(19) United States
(12) Patent Application Publication
(10) Pub. No.: US 2002/0035789 A1
(43) Pub. Date: Mar. 28, 2002

(54) Cutting device

(76) Inventor: Moritz Muhlebach, Dietlikon (CH)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/964,873

(22) Filed: Sep. 28, 2001

(30) Foreign Application Priority Data
Sep. 28, 2000 (DE) 100 49 240.1

(51) Int. Cl. B26B 25/00

(52) U.S. Cl. 30/319; 30/295

(57) ABSTRACT

A cutting device (1) for floor coverings, intended for cutting or starting a tear of seams, includes a base body (2) with at least one blade (3) that is mounted on the base body (2), and a contact edge (4), envisioned on the bottom side (5) of the base body (2), for an edge of a floor covering. A removable first plate (6) and a removable second plate (7) are attached in the front area of the base body (2), and the blade (3) can be arranged parallel to the contact edge (4) between the plates (6, 7). To provide a cutting device (1) that allows for the simple adjustment of the cutting width, at least one additional plate (8, 9, 10) is provided, allowing the blade (3) to be arranged, if necessary, between the second plate (7) and the additional plate (8) or between adjacent additional plates (8, 9, 10).

### BACKGROUND OF THE INVENTION

1. Field of the Invention

The invention relates to a cutting device for floor coverings, intended for cutting or starting a tear of seams, including a base body and at least one blade that is held to the base body, and with a contact edge on the bottom side of the base body for an edge of a floor covering. In the front part of the base body, a removable first plate and a removable second plate are attached to the base body, and the blade can be arranged parallel in relation to the contact edge between the plates.

2. The Prior Art

A cutting device of the above-noted type is already known from practical applications. The cutting device that is known includes exactly two plates that have a blade arranged between them. Arranging the blade between the first plate and the base body in order to cut or start a tear of a seam is not possible, because the first plate follows immediately after the contact edge. Even though the known cutting device has a blade arranged between the first plate and the base body, this is only a back-up blade, which is only stored between the first plate and the base body and does not extend beyond the base body. Therefore, any cutting action with the substitute blade is not possible. It is disadvantageous that, due to the selected two-plate-arrangement, the cutting width of the known cutting device cannot be adjusted, i.e. the distance between the contact edge and the blade cannot be adjusted.

Therefore, it is the object of the present invention to provide a cutting device of the noted kind that will allow for simple cutting width adjustments.

### SUMMARY OF THE INVENTION

According to the invention, this objective is achieved principally by including at least one additional plate, allowing the blade, if necessary, to be arranged between the second and the additional plate or between adjacent additional plates. The realization according to the invention allows for simple cutting width adjustments, because the blade is now arranged not only between the first plate and the second plate, but it can optionally also be arranged between the second plate and the additional plate or between additional adjacent plates. In known cutting devices the plates only fulfill a holding or clamping function. But the invention provides that, in addition to the holding function, the plates also serve as spacer blocks in order to modify the cutting width, which is the distance between the blade and the contact edge.

In order to be able to adjust to different cutting widths, at least one plate has a different width than another plate. Utilizing different width dimensions for individual or for all plates makes adjustments to different cutting widths possible.

The individual plates are arranged on the base body inside a recess that is accessible at least from the front end side and the bottom side. The recess is laterally enclosed by at least one wall. In principle, it is also possible to envision two lateral walls, and the individual plates as well as the blade can be arranged between the walls.

A clamping device is used for mounting and fastening the removable plates to the base body. In a preferred embodiment, a clamping device is a screwed connection comprised of screw and nut, with the screw being inserted through the wall and the plates.

Furthermore, the present invention relates to a cutting device for floor coverings, intended for cutting or starting a tear of seams, comprised of a base body and at least one blade that is mounted to the base body, and with a contact edge provided on the bottom side of the base body for an edge of a floor covering. In this instance, the blade extends with its cutting edge beyond the bottom side of the base body.

The cutting device of the kind referred to above also corresponds to a cutting device that was outlined previously, and which is known from practical applications, providing for the blade to be held on the base body between the first plate and the second plate. The blade is mounted by way of a clamped joint. The clamped joint is also used for clamping the plates in place. For this purpose, the blade is positioned on the attachment screw and can be swung out by its cutting edge from between the two plates, if necessary, thereby causing the cutting edge to extend beyond the bottom edge of the base body, depending on the desired cutting depth.

A disadvantageous aspect of the cutting device that is known in the art is that the front end of the blade is set back in relation to the leading edge or the front end of the base body, which is why complete cutting of the seam up to the limit stop is not possible anyway. But it is also important to note that wall-to-wall cutting is also not possible since there is a considerable gap between the back end of the blade and the back end of the base body. To allow for wall-to-wall cutting action with the realization that is known in the art, two blades would have to be envisioned; in particular, one blade in the area of the front end side and one blade in the area of the back end side of the base body. This realization is known from cutting devices in practical applications that are realized as a type of seesaw.

Therefore, it is an object of the present invention to provide a cutting device of the type referred to above that will allow easy wall-to-wall cutting action.

According to the invention, this object is achieved, in principle, by providing that the blade also extends beyond the front end side of the base body and that the cutting edge or another cutting edge extends to the front end side as well. The advantages afforded by the realization according to the invention are twofold. On the one hand, using the blade extending on the front end side, it is possible to cut a covering up to a cross edge. By envisioning this cutting edge or another cutting edge on the front end side it is possible to swing the base body to such a degree that the front end side becomes arranged on the bottom side, resulting in the fact that the covering can now be cut up to its other cross edge, i.e. ultimately wall-to-wall, in particular by using a single blade and performing a single cut.

To ensure proper handling during the swinging action of the knife as well, it is envisioned according to the invention that the contact edge also extends along the front end side of the base body. Thus, the contact edge is envisioned on the front end side and on the bottom side, and it is able to exercise its guiding function in both conditions.

Moreover, it is particularly advantageous that the bottom side cutting depth and the front side cutting depth are at least essentially equal. Utilizing a corresponding blade position, with the blade ultimately extending equally beyond the base body on the bottom side as well as on the front end side, it is possible to always achieve the same cutting depth, irrespective of how the base body is held.

To be able to move the base body toward a wall using its front end side or its bottom side, both sides are arranged, at least in some areas, at a right angle in relation to each other.

Even though, as a rule, it is possible for the blade to have multiple corners and multiple cutting edges, it is most convenient if the blade has at least one arc-shaped cutting edge that extends from the bottom side to the front end side. In this instance, the blade is preferably realized as disc-shaped, featuring a cutting edge that runs the entire circumference of the blade.

To preclude the risk of injury that may ensue due to the blade extending on the front end side, a protective cover is envisioned on the front end side that covers the blade, seen from a top view, at least in part. Preferably, the protective cover stands out far enough over the front end of the base body to preclude any contact of the hand of the user with the blade, should the hand of the user slip off the base body. The width of the protective cover corresponds, in essence, at least to the width of all plates, thereby ensuring that, irrespective of the adjusted cutting width, the protective function will always be satisfied.

A guide is envisioned on the base body that receives the protective cover in order to avoid that the protective cover becomes an obstacle for the swinging action of the blade during wall-to-wall cutting. The protective cover can be moved into this guide. This is either done manually before the swinging action of the base body or it occurs when the protective cover rests on the floor covering during the swinging action of the base body, and it is then pushed into the guide due to the swinging motion.

It is particularly preferred if the protective cover is spring-loaded from the direction of the receptacle. This way it is ensured that, first of all as a matter of principle, the protective cover is arranged on the outside of the base body, thereby fulfilling its covering function and protective function. During the swinging motion of the base body the protective cover is automatically pushed into the guide when it contacts the floor. When the base body is swung downward again, the protective cover is moved out of the guide once again via the spring action.

Moreover, the invention relates to a cutting device for floor coverings, intended for cutting or starting a tear of seams, comprised of a base body and at least one blade that is mounted to the base body, and with a contact edge provided on the bottom side of the base body for an edge of a floor covering.

As referred to previously, to adjust the cutting depth of the blade of the cutting device that is known from practical applications, the attachment screw is first loosened, then the blade is manually adjusted to the desired cutting depth. During the adjustment process the blade must be touched by hand, which constitutes a high injury risk due to cuts.

Therefore, an object of the present invention consists also in providing a cutting device of the kind referred to above that will prevent injuries from occurring during the adjustment process of the cutting depth.

In essence, according to the invention this object is achieved by utilizing an adjustment device that is comprised of at least one adjusting lever for adjusting the cutting depth of the blade. Thus, contrary to the state of the art, the present invention envisions a special adjustment device, which holds the blade, for adjusting the cutting depth. To provide ease of operation, it is advantageous if the adjustment device can be operated from the top side of the base body.

Preferably, the adjusting lever is comprised of a first lever that runs through the base body, and of a cross lever that runs in a transversal direction in relation to the former and on which the blade is positioned. As part of the adjusting lever the cross lever is movable, thereby allowing blade adjustments. However, mounting the blade to the screw of the clamping device is not envisioned.

It is also useful if the blade is mounted on the cross lever with the ability to rotate safely. This results in a good cutting effectiveness of the blade, in particular, even if the clamping device is not tightened very much. If the cutting edge of the blade located on the outside has become dull, the blade is detached and, in particular applicable for disc-shaped realizations of the blade, it is rotated until another sharp cutting edge has been moved to the outside.

The individual plates feature a guide slot for the cross lever that is open toward the top side, thereby making the adjusting movement of the cross lever, including the blade mounted thereon, inside the base body possible. The cross lever can be moved along this slot in order to adjust the cutting depth.

To be able to adjust the cutting depth not only on the bottom side but, simultaneously, also on the front end side, the first lever of the adjusting lever runs at a transverse angle through the base body. The transverse arrangement of the first lever, which is movable inside the base body, ensures the simultaneous bottom side and front side adjustment of the cutting depth of the blade.

A control means is envisioned to operate in conjunction with the adjusting lever for adjusting the cutting depth. The control means can consist of, for example, a linearly movable adjusting slide or a locking screw. If a linearly movable adjusting slide is used, realizing corresponding slide planes can be envisioned in order to ensure the linear movement of the adjusting slide inside the transversely guided movement of the adjusting lever. It is beneficial if the adjusting lever is equipped with springs, irrespective of the type of control means, in order for the adjusting lever to be retracted as well when the control means is retracted, utilizing the spring.

Furthermore, it makes sense to envision an adjustment scale in the area of the control means that indicates the cutting depth and thereby informs the user as to the correct cutting depth.

Additional characteristics can be understood from the subsequent description of embodiments taken with the accompanying drawings.

### BRIEF DESCRIPTION OF THE DRAWINGS

FIG. 1 shows a schematic rear end view of the cutting device according to the invention, showing some of its internal features;

FIG. 2 shows a schematic side view of the cutting device according to the invention, also showing some of its internal features;

FIG. 3 shows a rear view of the cutting device according to the invention; and

FIG. 4 shows a top view of the cutting device according to the invention.

### DETAILED DESCRIPTION OF THE PREFERRED EMBODIMENTS

The figures depict a cutting device 1 that cuts or starts tears of seams. Used as floor coverings are materials such as CV (Cushel Vinol), linoleum, needled felt, carpet felt, PVC, rubber or cork. The cutting device 1 includes a base body 2, a blade 3 and a contact edge 4. The blade 3 is mounted to the base body 2, while the contact edge 4 is envisioned on the bottom side 5 of the base body 2. The contact edge 4 that extends, at least in essence, across the entire bottom side 5 of the base body 2 is used for applying an edge to the floor covering. A removable first plate 6 and a removable second plate 7 are fastened in the front end area of the base body 2, while the blade 3 can be arranged parallel to the contact edge 4 and between the plates 6, 7.

First of all, it is important that at least one additional plate 8, 9, 10 is provided to enable the blade 3 to be located between the second plate 7 and the additional plate 8 or between adjacent additional plates 8, 9, 10. The embodiment that is described here envisions three other plates 8, 9, 10 in addition to the first two plates 6, 7. Using the individual plates 6, 7, 8, 9, 10, different cutting widths can easily be adjusted, in particular since individual plates have different widths. Thus, in the present case, the plate 7 has the smallest width, while plate 6 is approximately twice as wide as plate 7. Plate 8 has the approximate width of plate 7. The width of plate 9 and of plate 10 each corresponds to multiple widths of plate 8. Naturally, it is possible to select other width dimensions for the individual plates as well. In terms of their arrangement in relation to each other, the plates are combined, if necessary, for the respectively envisioned cutting widths.

At least one recess 11 that is accessible from the front end side and from the bottom side is provided in the base body 2 for the plates, and in which the individual plates 6, 7, 8, 9, 10 are arranged. In the embodiment shown the recess 11 is open on its side, featuring only a lateral enclosure, which is constituted by wall 12 of the base body 2. An end piece 13 is envisioned on the opposite side subsequent to the last plate 10. However, in principle, it is also possible to realize the end piece as one piece with the wall of the base body 2.

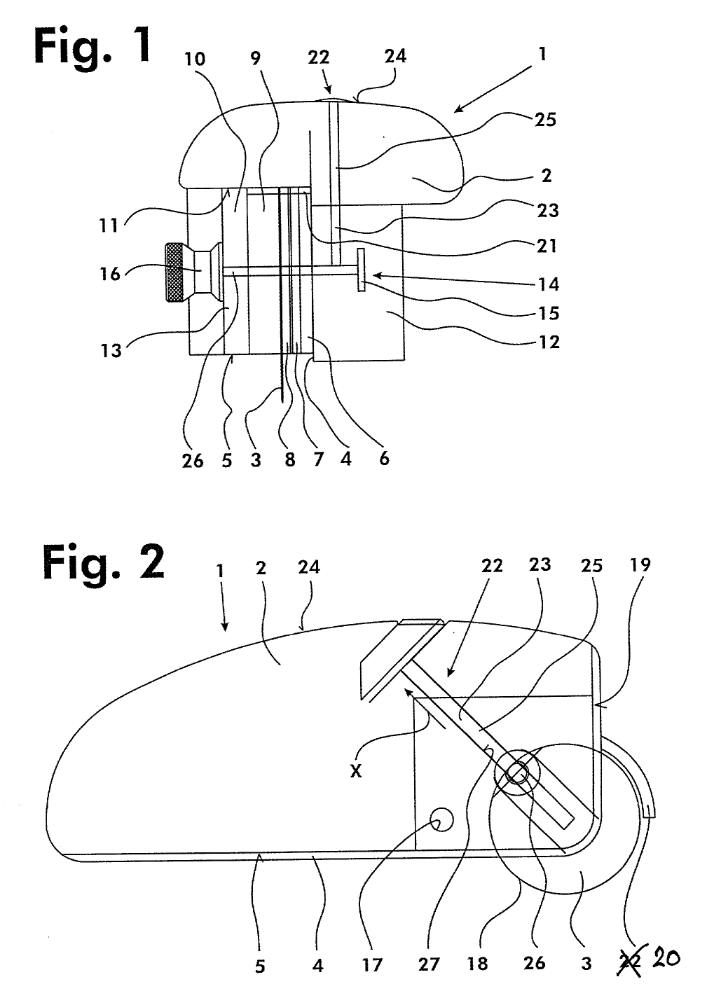

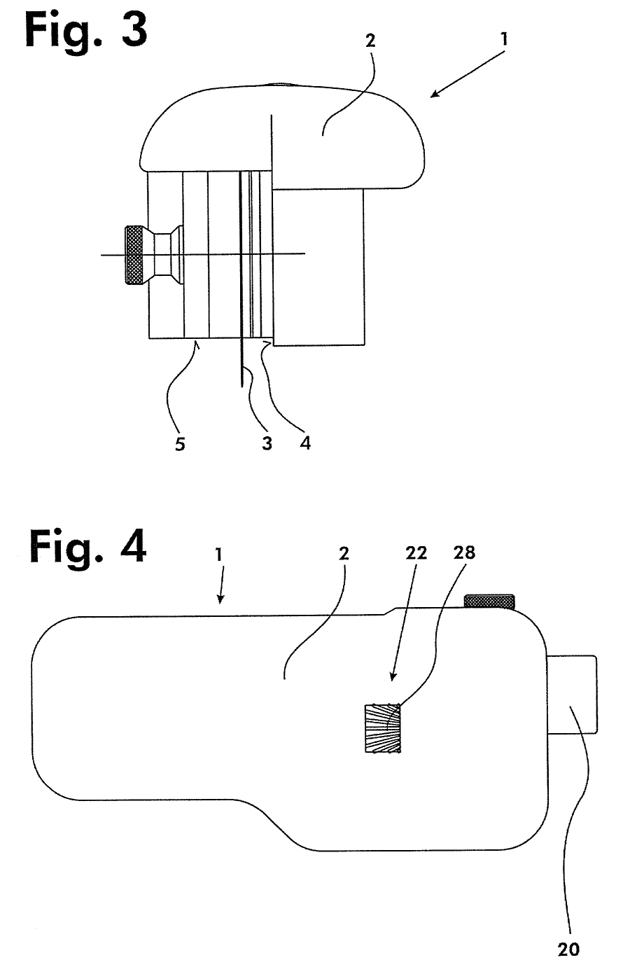

Furthermore, a clamping device 14 is utilized for fastening the removable plates 6, 7, 8, 9, 10, and the end piece 13 on the base body 2. In the present embodiment the clamping device 14 is realized as a screwed connection, consisting of a screw 15 and a wing nut 16. As shown in FIG. 1, the screw 15 penetrates through the wall 12, the plates 6, 7, 8, 9, 10 and the end piece 13. FIG. 2 shows a corresponding opening 17 for the screw inside the wall 12. Corresponding openings are also envisioned in the plates 6, 7, 8, 9, 10 and the end piece 13.

As seen in particular in FIG. 2, the blade 3 extends with its cutting edge 18 beyond the bottom side 5 of the base body 2. It is important in this context that the blade 3 also extends beyond the front end 19 of the base body 2, and that the cutting edge 18 extends to the front end side as well, i.e., it is envisioned on the front end side, thereby allowing cutting action on the front end 19 of the base body 2. All that is necessary for accomplishing this is that the blade be rotated by approximately 90° in relation to the condition depicted in FIG. 2. In order to be able to maintain the desired cutting width in this situation, the contact edge 4 also extends from the bottom side 5 along the front end side 19 of the base body 2. Moreover, the bottom side 5 and the front end side 19 of the base body 2 are also -arranged at a right angle in relation to each other following a rounded transition in the area of the apex.

As further seen in FIG. 2, the blade 3 is disc-shaped or circular, exhibiting a cutting edge 18 running around its circumference. Principally, however, it would also be possible to envision a blade that is not realized as circular, but that has an arc-shaped cutting edge in the area that is outside of the base body 2.

A protective cover 20 is envisioned on the front end side of the base body 2 that covers the blade from the top. The width of the protective cover 20 corresponds approximately to the width of the plates 6, 7, 8, 9, 10 in order for the protective cover to be able to fulfill its protective function at each cutting width. In the present embodiment a guide 21 is envisioned inside the base body 2 as a receptacle for the protective cover 20. In terms of its shape, the guide 21 is adjusted to the protective cover 20 allowing the protective cover 20 to be pushed into the guide 21. It is not shown here that the protective cover 20 is spring-loaded from the direction of the guide 21. A spring element, not shown, acting upon the protective cover 20 is envisioned for this purpose.

Also important in the context of the present invention is an adjustment device 22 comprised of at least one adjusting lever 23 for adjusting the cutting depth of the blade 3. Contrary to the state of the art, the blade 3 is not mounted to the screw 15 of the clamping device 14, but it is positioned on the adjusting lever 23. The adjustment device 22 can be operated from the top side 24 of the base body 2. The adjusting lever 23 is equipped with a first lever 25, running through the base body 2 in the adjustment direction 22, as well as a cross lever 26, running at a transverse angle in relation to the former. The blade 3 is positioned on the cross lever 26. The first lever 25 and the cross lever 26 are realized in one piece in the displayed embodiment.

The blade 3 is mounted to the cross lever 26 with the ability to rotate safely, even though this is not described in detail. For the adjusting lever 23, and consequently also the cross lever 26, to be able to be adjusted subsequent to the loosening of clamping device 14, the individual plates 6, 7, 8, 9, 10 each feature a guide slot 27 that is open toward the top side 24, and the cross lever 26 is movable inside said slot. As seen in particular in FIG. 2, the first lever 25, moreover, runs diagonally through the base body 2. Correspondingly, the guide slot 27 is diagonally slanted.

Furthermore, the adjustment device 22 is equipped with a control means 28 that is accessible from the top side 24, acting in conjunction with the adjusting lever 23 to adjust the cutting depth. The control means 28 can consists of a linearly movable adjusting slide whose upper outside surface is contoured to improve the grip. Accordingly, a slant can be envisioned on the bottom side on the adjusting slide, acting in conjunction with a corresponding slant on the adjusting lever in order to effect a diagonal linear movement of the adjusting lever 23.

In principle, it is also possible for the control means to be equipped with an adjusting screw that acts in conjunction with the adjusting lever 23. Also, the adjusting screw can also be envisioned on one of the outer sides of the base body. In this case it would make sense to envision an eccentric acting upon the adjusting lever on the adjusting screw. Essentially, the adjusting slide could also be arranged on one of the outer side[s].

In any case, the adjusting lever 23, which is also not shown, should be spring-loaded in the direction of the arrow X in order to be able to ensure a retraction of the adjusting lever 23.

Finally, a scale, also not shown, to indicate the cutting depth can also be envisioned in the area of the control means 28.

1. Cutting device (1) for floor coverings, intended for cutting or starting a tear of seams, comprised of a base body (2) with at least one blade (3), that is mounted on the base body (2), and comprised of a contact edge (4), envisioned on the bottom side (5) of the base body (2), for an edge of a floor covering; and a removable first plate (6) and a removable second plate (7) are fastened to the base body (2) in the front area of the base body (2); and the blade (3) can be arranged parallel to the contact edge (4) between the plates (6, 7) including one additional plate (8, 9, 10) for enabling the blade (3) to be arranged between the second plate (7) and the additional plate (8) or between adjacent additional plates (8, 9, 10).

2. Cutting device as claimed in claim 1 wherein at least one plate (6, 7, 8, 9, 10) has a different width than another plate.

3. Cutting device as claimed in claim 1 wherein the base body defines one recess (11) that is accessible at least from the front end side and the bottom side of the base body (2) for the plates (6, 7, 8, 9, 10), and wherein the recess (11) is laterally enclosed by at least one wall (12).

4. Cutting device as claimed in claim 1 including a clamping device (14) for fastening the removable plates (6, 7, 8, 9, 10) to the base body (2).

5. Cutting device as claimed in claim 4 wherein the clamping device (14) is a screwed connection consisting of screw (15) and nut (16) and wherein the screw (15) penetrates the wall (12) and the plates (6, 7, 8, 9, 10).

6. Cutting device (1) for floor coverings, intended for cutting or starting a tear of seams, comprised of a base body (2) and a blade (3) that is mounted on the base body (2), said base body defining a contact edge (4) on a bottom side (5) thereof for an edge of a floor covering; and the blade (3) extends with its cutting edge (18) beyond the bottom side (5), wherein the blade (3) also extends beyond the front end side (19) of the base body (2) and wherein the cutting edge or another cutting edge (18) of the blade (3) is on the front end side.

7. Cutting device as claimed in claim 6 wherein the contact edge (4) also extends along the front end side (19) of the base body (2) and wherein the bottom side cutting depth and the front end side cutting depth are at least essentially equal.

8. Cutting device as claimed in claim 6 wherein the bottom side (5) and the front end side (19) of the base body (2) are at least in part arranged approximately at a right angle in relation to each other.

9. Cutting device as claimed in claim 6 wherein the blade (3) is equipped with at least one arc-shaped cutting edge (18).

10. Cutting device as claimed in claim 6 wherein the blade (3) is disc-shaped and equipped with a cutting edge (18) that runs along its circumference.

11. Cutting device as claimed in claim 6 including a protective cover (20) on the base body (2) in order to cover, at least partially, the blade (3) from the top side.

12. Cutting device as claimed in claim 6 wherein a width of the protective cover (20) corresponds at least in essence to a total width of plates (6, 7, 8, 9, 10).

13. Cutting device as claimed in claim 12 including a guide (21) for the purpose of receiving the protective cover (20).

14. Cutting device as claimed in claim 13 wherein the protective cover (20) is spring-loaded from the direction of the guide (21).

15. Cutting device (1) for floor coverings, intended for cutting or starting a tear of seams, comprised of a base body (2) and a blade (3) that is mounted on the base body (2), and comprised of a contact edge (4) on the bottom side (5) of the base body (2) for an edge of a floor covering, including an adjustment device (22) comprised of at least one adjusting lever (23) for the adjustment of the cutting depth of the blade (3).

16. Cutting device as claimed in claim 15 wherein the adjustment device (22) can be operated from the top side (24) of the base body (2).

17. Cutting device as claimed in claim 15 wherein the adjusting lever (23) is equipped with a first lever (25), running through the base body (2), and a cross lever (26), running transversely in relation to the former, and wherein the blade (3) is positioned on the cross lever (26).

18. Cutting device as claimed in claim 17 wherein the blade (3) is mounted to the cross lever (26) with the ability to rotate safely.

19. Cutting device as claimed in claim 18 wherein including plates (6, 7, 8, 9, 10) with a guide slots (27) for the cross-lever (26) that is respectively open on the top side (24).

20. Cutting device as claimed in claim 19 wherein the first lever (25) runs transversely through the base body (2).

21. Cutting device as claimed in claim 20 including a control means (28), acting in conjunction with the adjusting lever (23), for the adjustment of the cutting depth.

22. Cutting device as claimed in claim 21 wherein the control means (28) is equipped with a linearly movable adjusting slide.

23. Cutting device as claimed in claim 22 wherein the control means (28) is equipped with a locking screw.

24. Cutting device as claimed in claim 23 wherein the adjusting lever (23) is spring-loaded in the direction toward the top side (24).

25. Cutting device as claimed in claim 24 including a scale for displaying the cutting depth is envisioned in the area of the control means (28).
